(19) United States
(12) Patent Application Publication
(10) Pub. No.: US 2011/0141236 A1
(43) Pub. Date: Jun. 16, 2011

(54) THREE-DIMENSIONAL VIDEO IMAGE TRANSMISSION SYSTEM, VIDEO IMAGE DISPLAY DEVICE AND VIDEO IMAGE OUTPUT DEVICE

(76) Inventors: Hiroshi Mitani, Osaka (JP); Toshiroh Nishio, Osaka (JP)

(21) Appl. No.: 13/059,068

(22) PCT Filed: Sep. 1, 2009
(86) PCT No.: PCT/JP2009/004282

§ 371 Date: Feb. 15, 2011

(30) Foreign Application Priority Data
Sep. 2, 2008 (JP) 2008-224402
Dec. 9, 2008 (JP) 2008-312867

(51) Int. Cl. H04N 13/00

(52) U.S. Cl. 348/43; 348/E13.001

(57) ABSTRACT

In a recording and reproducing device, compressed 3D video image data recorded on an optical disc is reproduced by a recording and reproducing unit and decompressed to baseband 3D video image data by a codec. A format converting unit converts the recording format of the optical disc into the transmission format of HDMI in accordance with the display capability of the display device preliminarily acquired and outputs the resulting data. The format converting unit of the display device converts the transmission format of 3D video image data received through an HDMI cable into a display format. A display control unit displays 3D video image data converted into the display format on the display panel.

### TECHNICAL FIELD

The present invention relates to a three-dimensional video image transmission system, and a video image display device and a video image output device composing the system, particularly to those transmitting three-dimensional video images through an interface compliant with the HDMI standard.

### BACKGROUND ART

Conventionally, various types of methods have been devised for stereovision of TV images. These methods, using binocular parallax. alternately present right- and left-eye images specially or temporally on a single display, to provide three-dimensional images when viewed by a viewer wearing special glasses or with the naked eye.

Recently, devices have been widely used with HDMI (High Definition Multimedia Interface) terminals compliant with the HDMI standard. For example, connecting a TV to a DVD recorder with an HDMI connecting cable allows sending and receiving high-quality video and audio data as well as some types of control information between the devices.

In the meantime, video image formats for TV include SD (standard definition) and HD (high definition), where a large number of HD formats different in the number of scan lines and frame rate have already been prevailing in the world.

Meanwhile, video devices such as a TV and DVD recorder are usually different in functionality and capability depending on such as manufacturers, release time, and price ranges, where video image formats able to send and receive are often different among devices.

Hence, video and audio data in formats incompliant with each other cannot be communicated successfully. Such a problem can be solved by using some types of control information supported by HDMI.

For example, to reproduce audio and video data recorded in a DVD recorder and to output the data on a TV through an HDMI connecting cable, the following method is used. That is, EDID (extended display identification data) information (e.g. display capability of the TV) stored in a ROM is acquired from the TV preliminarily; the format is converted into that displayable on the TV; and the data is output on the TV (refer to patent literature 1 for example).

However, with conventional methods including that in patent literature 1, transmission of three-dimensional video images is not considered, thus leaving disadvantages in connecting between devices for transmitting three-dimensional video images.

### [Prior Art Documents]

### [Patent Literature]

[Patent literature 1] Japanese Patent Unexamined Publication No. 2007-180746

### SUMMARY OF THE INVENTION

A three-dimensional video image transmission system of the present invention includes at least one video image display device for displaying three-dimensional video images and at least one video image output device for outputting three-dimensional video images. The system transmits three-dimensional video images output from the video image output device to the video image display device through an interface compliant with an HDMI standard. A three-dimensional video image is formed of left- and right-eye video images. The first interlaced scan data of left- and right-eye video images is transmitted during the first field and its subsequent second field. The second interlaced scan data, complementary to the first one, is transmitted during the third and fourth fields subsequent to the second one.

By adding a V synchronizing signal once for every four fields when transmitting three-dimensional video images from the video image output device to the video image display device through HDMI, such a configuration allows the display device to easily identify the four fields from the V synchronizing signal.

The video image display device of the present invention receives three-dimensional video images output from the video image output device through an interface compliant with the HDMI standard and displays the images, in the three-dimensional video image transmission system. The display device includes an HDMI receiving unit for receiving three-dimensional video image data transmitted from the video image output device in a given transmission format; a format converting unit for converting the transmission format into a display format; a display unit for displaying three-dimensional video images converted to the display format; and a storage unit for storing information on capability of displaying three-dimensional video images.

Such a configuration allows the video image display device to receive three-dimensional video image data output from the video image output device and to display the data.

The video image output device of the present invention transmits three-dimensional video images to the video image display device through an interface compliant with the HDMI standard, in the three-dimensional video image transmission system. The output device includes a video image acquiring unit for acquiring three-dimensional video images in a given video image format; a format converting unit for converting the given video image format into a transmission format; and an HDMI transmitting unit for transmitting three-dimensional video image data converted to the transmission format.

Such a configuration allows the video image output device to acquire information on the display capability of the display device through HDMI, which enables transmitting three-dimensional video image data adapted to the display device.

### BRIEF DESCRIPTION OF DRAWINGS

FIG. 1 shows a configuration example of a three-dimensional video image transmission system according to the first exemplary embodiment of the present invention.

FIG. 2 illustrates the overview of HDMI.

FIG. 3 shows an example of parameters representing the capability (display capability and receiving capability) of a display device according to the first embodiment of the present invention.

FIG. 4A illustrates the time sequential method, which is a display method (3D method) of a 3D video image.

FIG. 4B illustrates the polarized light method, which is a display method (3D method) of a 3D video image.

FIG. 4C illustrates the lenticular method, which is a display method (3D method) of a 3D video image.

FIG. 4D illustrates the parallax barrier method, which is a display method (3D method) of a 3D video image.

FIG. 5A illustrates the dot interleaved method, which is a transmission format (3D format) of 3D video image data.

FIG. 5B illustrates the line interleaved method, which is a transmission format (3D format) of 3D video image data.

FIG. 5C illustrates the side by side method, which is a transmission format (3D format) of 3D video image data.

FIG. 5D illustrates the over under method, which is a transmission format (3D format) of 3D video image data.

FIG. 5E illustrates the 2d+depth method, which is a transmission format (3D format) of 3D video image data.

FIG. 6 is a more detailed explanatory drawing of a 3D video image transmission format (3D format).

FIG. 7A illustrates an example of a transmission method in which L and R video images in the over under method are sent as one-frame video images

FIG. 7B illustrates an example of a transmission method in which L and R video images in the over under method are sent as two-frame video images.

FIG. 7C illustrates another example of a transmission method in which L and R video images in the over under method are sent as two-frame video images.

FIG. 8 shows an example of a transmission method (transmission format) for transmitting 3D video images by the interlace method.

FIG. 9 shows an example of mapping 3D video image data onto the currently used HD signal transmission format of 1125/60 i.

FIG. 10A shows a drawing for a case where an L video image is displayed fully on the display screen in order to describe the meaning of side priority.

FIG. 10B shows a drawing for a case where an R video image is displayed fully on the display screen in order to describe the meaning of side priority.

FIG. 11 illustrates a format (memory map) of EDID according to the first embodiment of the present invention.

FIG. 12A illustrates an AVI infoFrame format in the first embodiment of the present invention, showing the configuration of the packet header of vendor infoFrame.

FIG. 12B illustrates an AVI infoFrame format in the first embodiment of the present invention, showing the configuration of the packet content of a vendor infoFrame.

FIG. 13A illustrates a CEC format in the first embodiment of the present invention, showing the packet structure of a CEC frame composing a message.

FIG. 13B illustrates a CEC format in the first embodiment of the present invention, showing an example of a CEC frame for sending a parameter of group B in FIG. 3.

FIG. 14 shows a configuration example of a three-dimensional video image transmission system according to the second embodiment of the present invention.

### DETAILED DESCRIPTION OF PREFERRED EMBODIMENTS

Hereinafter, a detailed description is made of some embodiments of the present invention with reference to the related drawings.

### First Exemplary Embodiment

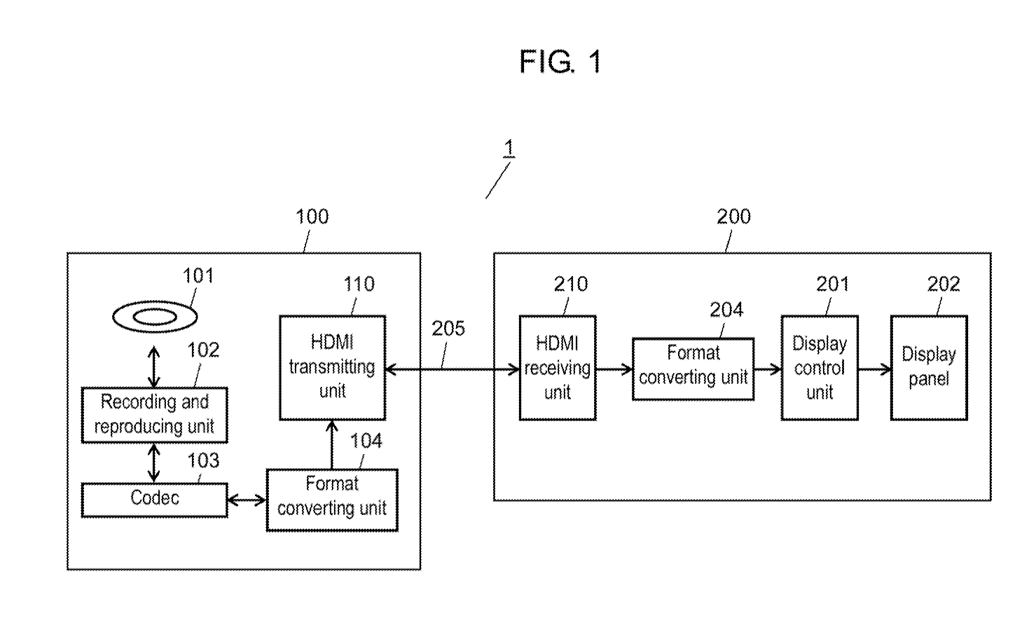

FIG. 1 shows a configuration example in a three-dimensional video image transmission system for transmitting three-dimensional video images (hereinafter, also referred to as 3D (dimensional) video image), according to the embodiment. In FIG. 1, three-dimensional video image transmission system 1 includes: video image recording and reproducing device (hereinafter, abbreviated as recording and reproducing device) 100 as a video image output device capable of reproducing three-dimensional video images; and video image display device (hereinafter, abbreviated as display device) 200 capable of displaying three-dimensional video images. Recording and reproducing device 100 and display device 200 are connected with HDMI cable 205.

Recording and reproducing device 100, which is a DVD recorder for example, includes optical disc 101, recording and reproducing unit 102, codec 103, format converting unit 104, and HDMI transmitting unit 110. Compressed 3D video image data, compressed using such as MPEG2 and recorded on optical disc 101, is reproduced by recording and reproducing unit 102 (as a video image acquiring unit), and decompressed to baseband 3D video image data by codec 103. Format converting unit 104 converts video image data from the recording format of optical disc 101 into the transmission format of HDMI. HDMI transmitting unit 110 sends out 3D video image data to display device 200 through HDMI cable 205. Recording and reproducing device 100 preliminarily acquires information on a transmission format receivable by display device 200 from display device 200 through HDMI, and format converting unit 104 performs format conversion on the basis of this information.

Here, non-compressed (baseband) 3D video images recorded on optical disc 101 eliminate codec 103.

Display device 200 includes HDMI receiving unit 210, format converting unit 204, display control unit 201, and display panel 202. HDMI receiving unit 210 receives 3D video image data transmitted through HDMI cable 205. Format converting unit 204 converts 3D video image data received from a transmission format into a display format. Display control unit 201 drive-controls display panel 202 (i.e. a display unit) using 3D video image data converted into the display format. Display panel 202 (e.g. a plasma display panel (PDP) or liquid crystal display (LCD)) displays 3D video images.

Here, 3D video image data is composed of two different video image data: left-eye video image data (hereinafter, may be abbreviated simply as L) and right-eye video image data (hereinafter, may be abbreviated simply as R). These two different video image data are separately transmitted and are combined together by format converting unit 204 to be displayed as 3D video images. The transmission format and display format are described in detail later.

In the above description, the number of recording and reproducing devices and display devices composing 3D video image transmission system 1 is one each; however, the number is not limited to this embodiment, but any number of devices may be used.

In the above description, audio data is not mentioned; however, audio data may be transmitted as required.

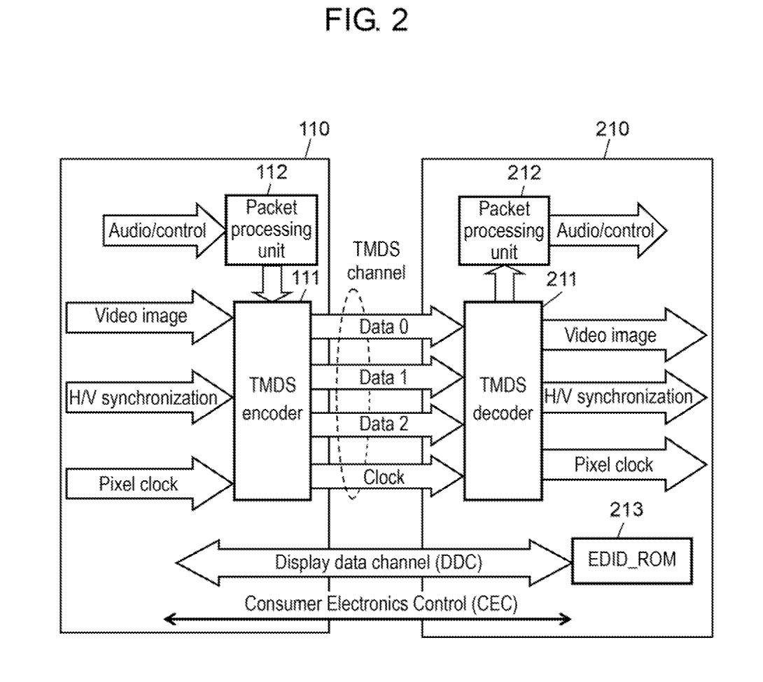

FIG. 2 illustrates the overview of HDMI. HDMI transmits video image data, audio data, and control information through the three channels: TMDS (Transition-Minimized Differential Signaling) channel, DDC (Display Data Channel), and CEC (Consumer Electronics Control) channel.

HDMI transmitting unit 110 includes TMDS encoder 111 and packet processing unit 112. HDMI receiving unit 210 includes TMDS decoder 211, packet processing unit 212, and EDID_ROM 213.

Video image data, H/V synchronizing signal, and a pixel clock are input into TMDS encoder 111: converted from 8-bit data into 10-bit data as well as into serial data by TMDS encoder 111; and sent out through the three TMDS data channels (data #0, data #1, data #2). The pixel clock is transmitted through the TMDS clock channel. The three data channels transmit data at a maximum transmission speed of 165 M pixels/second, which enables transmitting even video image data of 1080 P by HDMI.

Audio data and control data are formed into packets by packet processing unit 112; converted into a specific 10-bit pattern by TMDS encoder 111: and transmitted during a video image blanking period of two data channels. A 2-bit horizontal/vertical synchronizing signal (H/V synchronization) is converted into a specific 10-bit pattern and is superimposed during a blanking period of one data channel; and transmitted. Here, the control data includes auxiliary video image data called AVI (Auxiliary Video Information) infoFrame, which allows transmitting format information of video image data from recording and reproducing device 100 to display device 200. AVI infoFrame is described in detail later.

Information for representing the capability of display device (sink) 200 is stored as EDID information in EDID_ROM 213 as a storage unit. Recording and reproducing device (source) 100 can determine such as the formats of video image data and audio data to be output, for example, by reading the EDID information using the DDC.

CEC enables operating plural devices with one remote control unit, for example, by interactively transmitting control signals between devices Connected with HDMI.

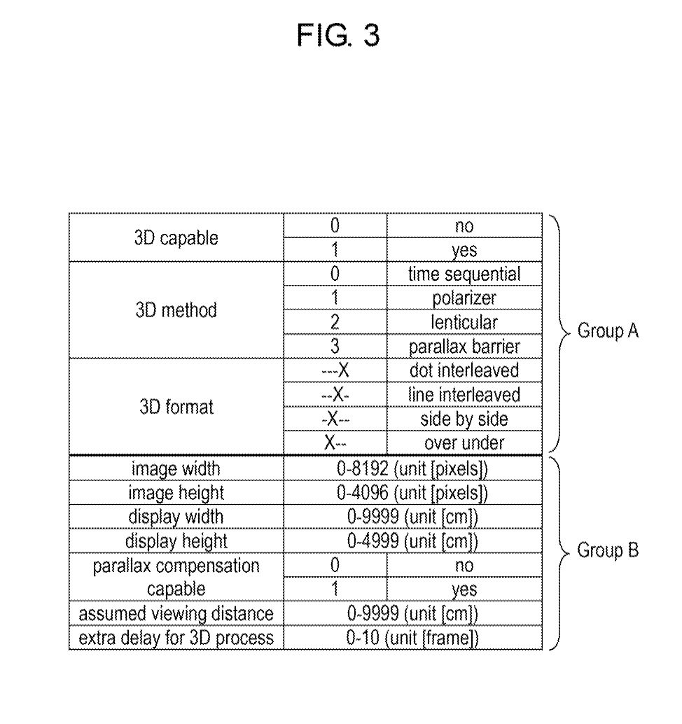

Next, a description is made of an example of parameters representing the capability (display and receiving capability) of display device 200 according to the embodiment using FIG. 3. These parameters are retained only by display device (sink) 200, not by recording and reproducing device (source) 100. Accordingly, the information is desirably acquired from display device 200 before recording and reproducing device 100 transmits 3D video image data in 3D video image transmission system 1. These parameters are acquired through the DDC channel (a parameter of group A) and the CEC channel (a parameter of group B). The details are described later.

In FIG. 3, “3D capable” indicates the capability of 3D dispaly of device 200 (1: 3D capable, 0: 3D incapable), and “3D method” indicates the method (also referred to as “display format” hereinafter) of displaying 3D video images of display device 200, and there are four methods: the time sequential method (0: time sequential), polarized light method (1: polarizer), lenticular method (2: lenticular), and parallax barrier method (3: parallax barrier).

The parameter “3D format” indicates a transmission format of 3D video image data receivable by display device 200, and there are four transmission formats: dot interleaved, line interleaved, side by side, and over under.

The image size (unit: pixel) includes the horizontal image size (image width) and vertical image size (image height), where the horizontal image size is changeable from 0 to 8,192 pixels, and the vertical image size is changeable from 0 to 4,096 pixels.

The screen size (unit: cm) has the horizontal screen size (display width) and vertical screen size (display height), where the horizontal screen size is changeable from 0 to 9,999 cm, and the vertical screen size is changeable from 0 to 4,999 cm.

The parameter “parallax compensation capable” indicates the capability of parallax compensation (1: compensation capable, 0: compensation incapable). This is because visual conditions such as viewing distance differ between viewing an original and viewing a 3D video image on display device 200, which requires parallax compensation. Parallax compensation is performed by shifting either one of the left-eye video image (also referred to as L video image, hereinafter) or the right-eye video image (also referred to as R video image, hereinafter) with respect to the other by a given number of pixels to display the images on the screen of display device 200. The number of pixels to be shifted at this moment is determined by the above image size, screen size, and viewing distance (the distance between the display device and the viewer).

The parameter “assumed viewing distance” (unit: cm) is viewing distance as a precondition for parallax compensation. The information (image size, screen size, assumed viewing distance) is required when parallax compensation is performed by recording and reproducing device 100, and the resulting video image data is transmitted to display device 200.

The last “extra delay for 3D process” (unit: frame) is a delay time generated at display device 200 for a 3D display process. The delay time is used to preliminarily execute a delay process at recording and reproducing device 100 for synchronizing (lip sync) video images with audio.

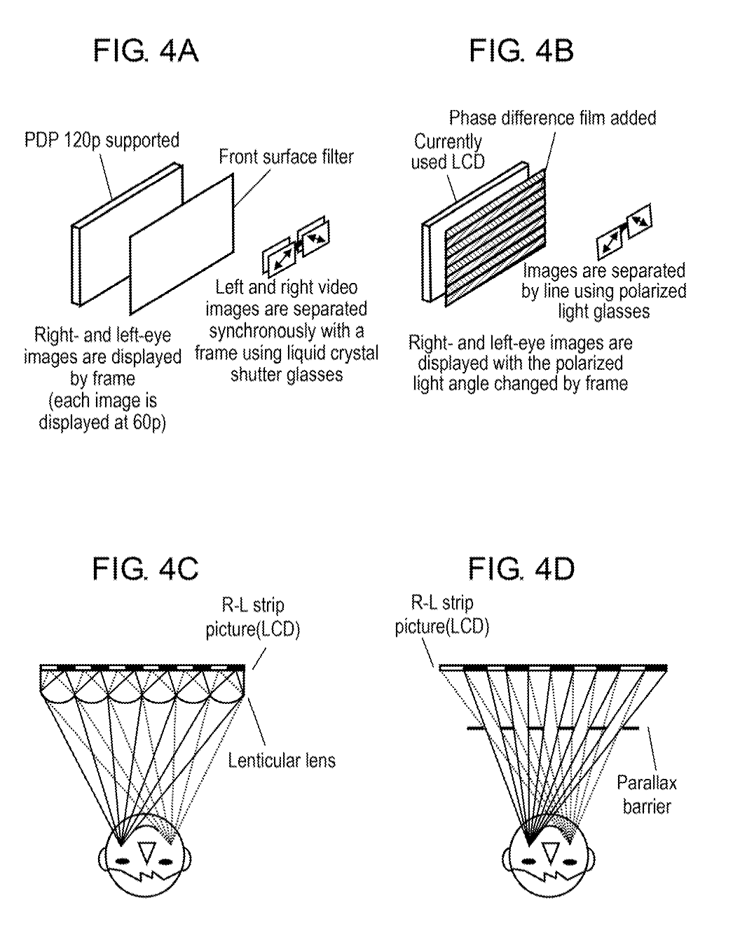

FIGS. 4A through 4D illustrate display methods (3D method) of 3D video images. There are following four types of methods according to such as the requirement for special glasses and the drive condition of the display panel.

FIG. 4A shows the time sequential method, in which L (left-eye video image) and R (right-eye video image) are displayed alternately for each frame on the display. Then the viewer separates the left and right video images synchronously with a frame using liquid crystal shutter glasses. Here, a shutter action of the liquid crystal shutter glasses is synchronized with a display frame through such as infrared transmission. For example, driving a display panel (e.g. a PDP) at 120 P allows displaying 3D video images at 60 P.

FIG. 4B shows the polarized light method, in which a polarized light element is overlaid on a display panel (e.g. the currently used LCD (liquid crystal display)) as a phase difference film, and L (left-eye video image) and R (right-eye video image) are displayed using polarized light orthogonalized for every line (horizontal scan line). The video images by lines with different polarizing directions are separated by line with polarized glasses to produces three-dimensional video images.

FIG. 4C shows the lenticular method, in which a special lens called a lenticular lens is placed on pixels to produce different video images depending on a viewing angle. A lenticular lens is produced by laying a large number of semi cylindrical convex lenses (the size of one piece corresponds to several pixels) in an array. L (left-eye video image) and R (right-eye video image) are once disassembled for each pixel and then rearranged (rendering) into each pixel of the display panel (e.g. an LCD). Such images, when viewed with both eyes, provide 3D video images due to different viewing angles between the right and left eyes. The method is characterized by enabling 3D video images to be viewed with the naked eye without wearing special glasses.

FIG. 4D shows the parallax barrier method, in which a barrier having apertures is placed in front of a display panel (e.g. an LCD), and 3D video images are provided using sight-line separation due to parallax caused by different angles at which sight lines pass through the apertures. The method also enables 3D video images to be viewed with the naked eye without wearing special glasses.

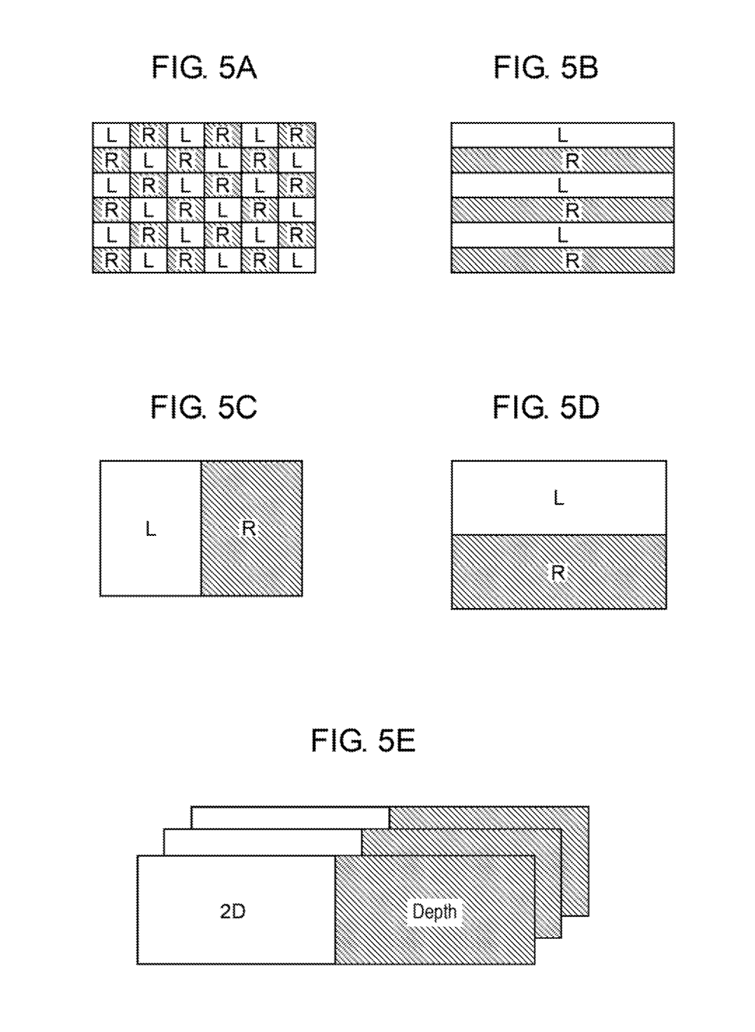

FIG. 5A through 5E illustrate transmission formats (3D format) of 3D video image data. The following five transmission formats are used in order to be adapted to such as a transmission condition and a display condition.

FIG. 5A shows the dot interleaved method, in which L and R video images are arranged in a frame in a checkerboard pattern.

FIG. 5B shows the line interleaved method, in which L and R video images are arranged in a frame alternately for each line.

FIG. 5C shows the side by side method, in which L and R video images are arranged in a frame before and after a line (on the left and right parts of the screen).

FIG. 5D shows the over under method, in which L and R video images are arranged in a frame chronologically (on the upper and lower parts of the screen).

FIG. 5E shows the 2d+depth method, in which a 3D video image is not expressed by L and R video images, but by pairs of a 2D video image and the depth of each pixel.

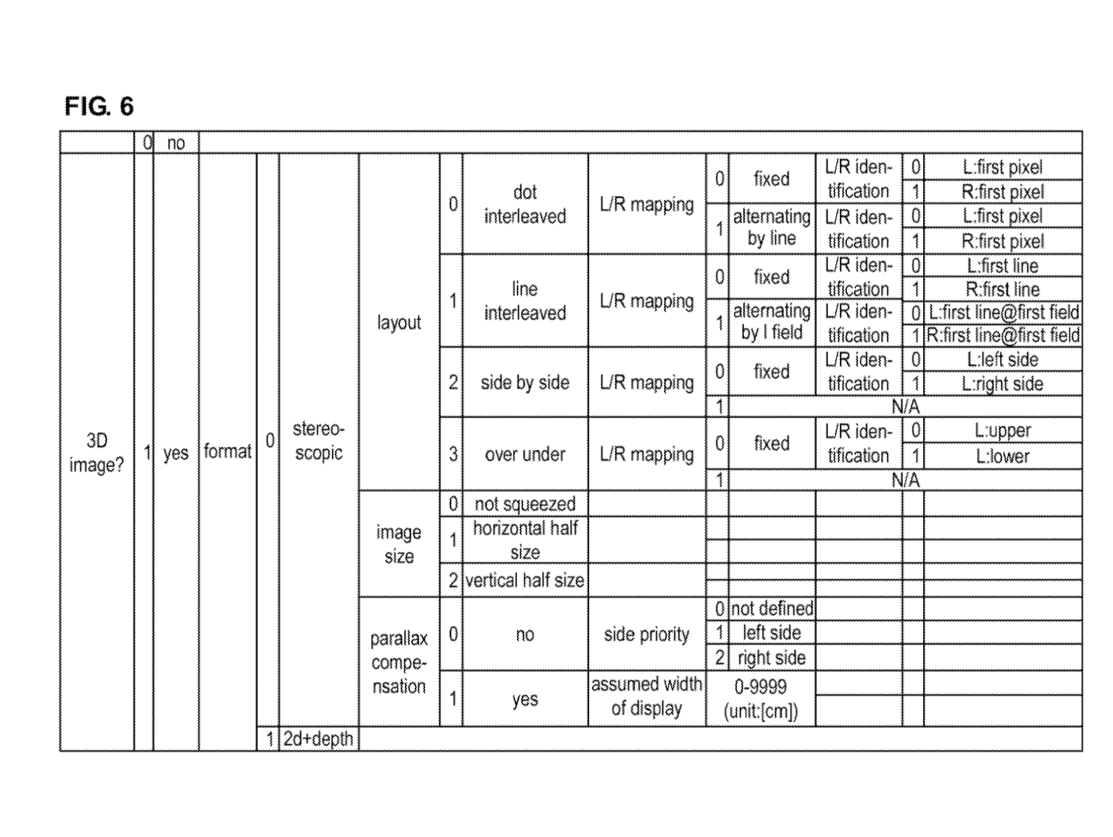

Next, a detailed description is made of each parameter of the transmission format (3D format) of 3D video images shown in FIG. 3 using FIG. 6. Each parameter is retained only by recording and reproducing device (source) 100, not by display device (sink) 200. Accordingly, the information is desirably transmitted from recording and reproducing device 100 to display device 200 when or before transmitting 3D video image data in 3D video image transmission system 1. These parameters are transmitted during a blanking period of video image data by AVI infoFrame of HDMI. A detailed description is made later.

Usually, the transmission format of 3D video image data transmitted by recording and reproducing device 100 is determined on the basis of information preliminarily acquired from display device 200. If display device 200 can receive plural transmission formats, recording and reproducing device 100 can select one of them. In this case, recording and reproducing device 100 is to transmit information on the transmission format selected to display device 200 by using AVI infoFrame.

In FIG. 6, “3D video image?” indicates whether or not video image data to be transmitted is 3D video images (1: 3D video images, 0: usual video images). The parameter “format” indicates two different formats depending on the 3D video image display method: glasses-worn method (0: stereoscopic) or naked-eye method (1: 2d+depth). Here, only the glasses-worn method is described.

The glasses-worn method includes three parameters: “layout”, “image size”, and “parallax compensation”. The parameter “layout” includes four 3D video image transmission formats described in FIGS. 3 and 5.

The parameter “L/R mapping” represents an arrangement for transmitting L and R video images. In the dot interleaved method (FIG. 5A), the parameter indicates (0: fixed) or (1: alternating by line). In the line interleaved method (FIG. 5B), the parameter indicates (0: fixed) or (1: alternating by field). Alternating L and R video images by line or field in this way provides a higher resolution of displayed video images than transmitting L and R video images in a fixed manner. In the side by side method (FIG. 5C) and over under method (FIG. 5D), (0: fixed) is always used.

The parameter “L/R identification” represents a transmission order of L and R video images. In the dot interleaved method, the parameter indicates that the first pixel is an L video image (0) or R video image (1). In the line interleaved method, the parameter indicates that the first line is an L video image (0) or R video image (1). In the side by side method, the parameter indicates whether an L video image is placed on the (0: left side) or (1: right side); in the over under method, (0: upper) or (1: lower).

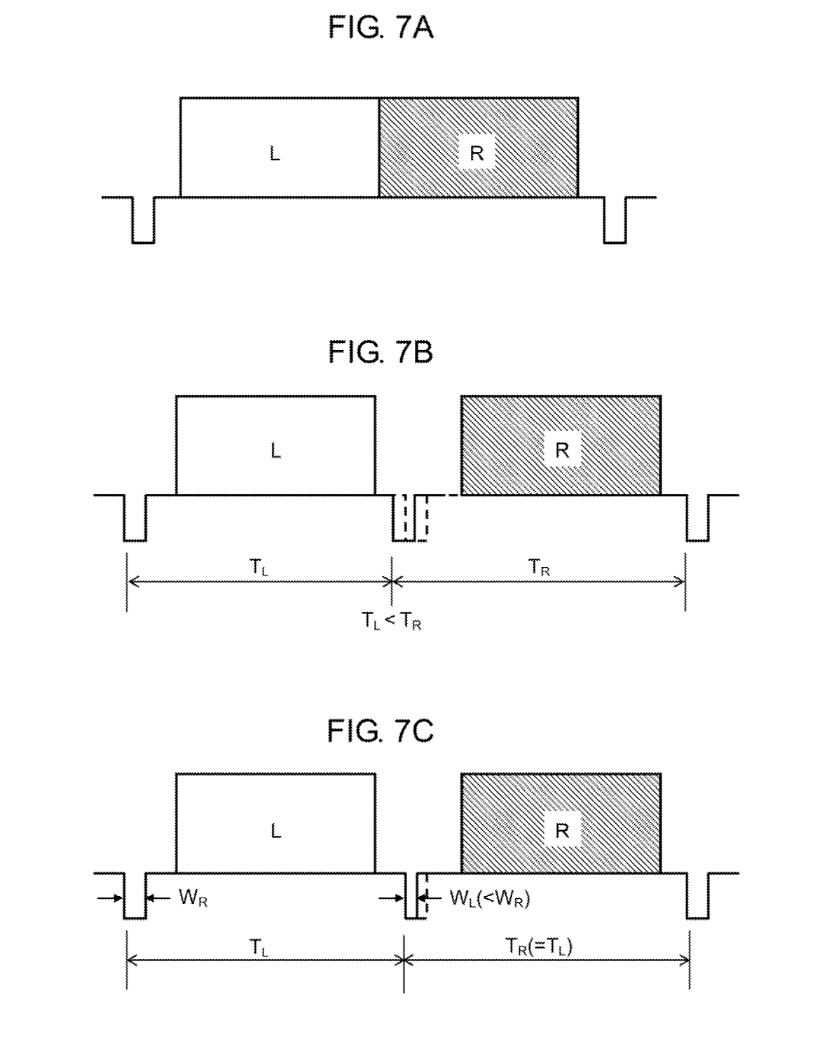

In the meantime, the over under method includes two different transmission methods as shown in FIGS. 7A, 7B, and 7C. One is sending L and R video images in one-frame video images as shown in FIG. 7A; the other, in two-frame separated video images as shown in FIGS. 7B and 7C. When sending images in one frame as in FIG. 7A, L and R video images can be easily identified by referring to a V synchronizing signal. On the other hand, when sending images in two frames as in FIGS. 7B and 7C, L and R video images cannot be identified by simply referring to a V synchronizing signal. To identify the images, information for identifying L and R video images can be sent by AVI infoFrame, which is not necessarily sent for every frame. Hence, as shown in FIG. 7B, interval TL of a V synchronizing signal for an L video image may be changed from interval TR for an R video image. Instead, as shown in FIG. 7C, width WL of a V synchronizing signal for an L video image may be changed from width WR for an R video image.

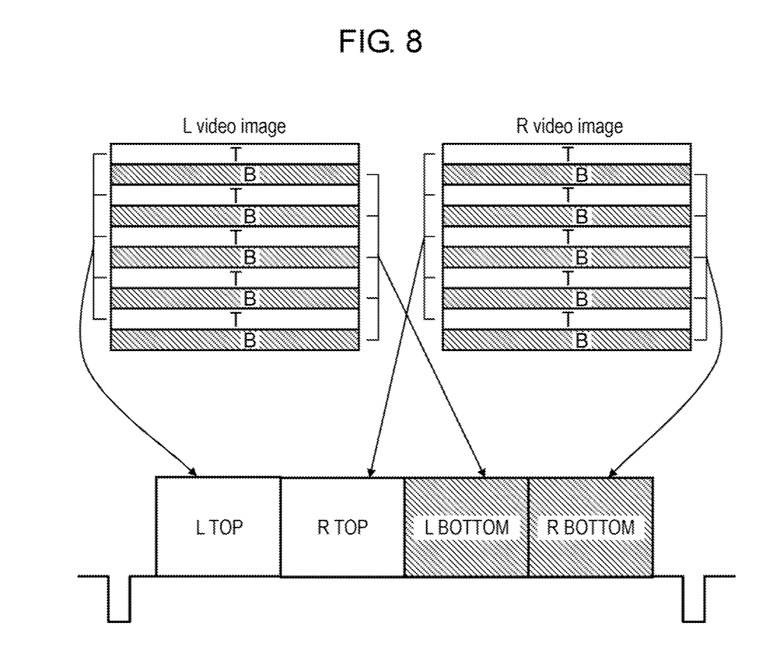

In FIG. 8, assumption is made that respective L and R video images of 3D video images are transmitted by the sequential scanning method (120 P), which requires twice the width of the transmission band as compared to 2D video images. To transmit 3D video images with the same transmission band as that for 2D video images, L and R video images may be transmitted by the interlace method. Transmitting 3D video images by the interlace method enables reducing by half not only the width of a transmission band but also the clock frequency of the processing circuit of display device 200, thereby decreasing the power consumption. Further, the amount of data to be processed is halved, so is the capacity of a working memory on display device 200, thereby reducing the cost of the processing circuit.

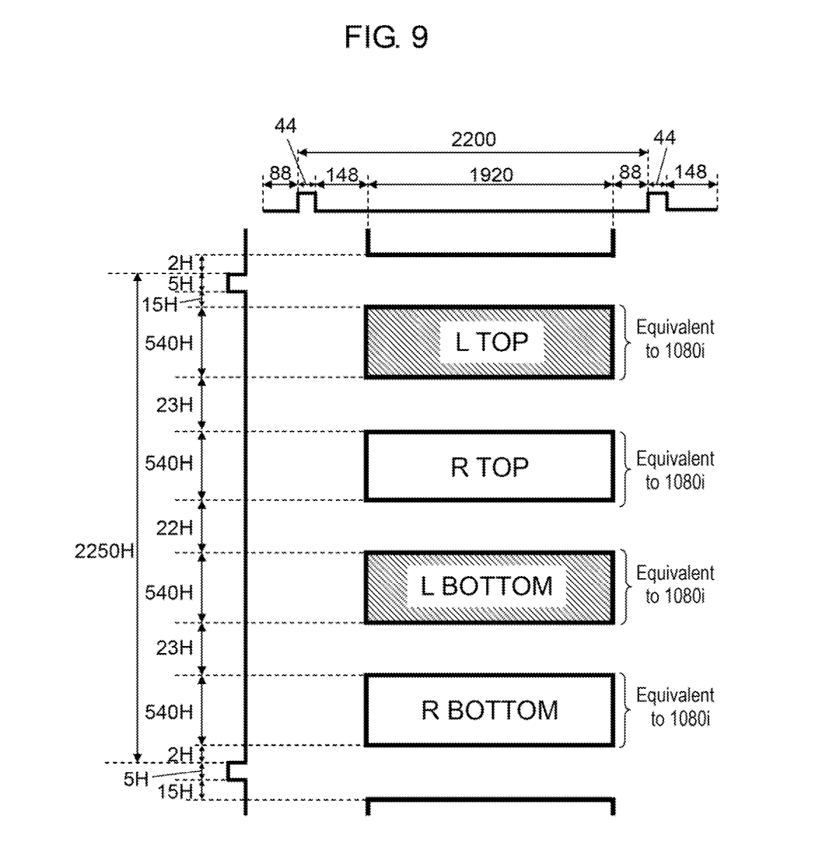

FIG. 8 shows an example of a transmission method (transmission format) for transmitting 3D video images by the interlace method. One frame of respective L and R video images is divided into TOP-field data (first interlace scan data) and BOTTOM-field data (second interlace scan data) complementary to each other, and then transmitted. For example, the TOP field of an L video image is sent during the first field out of the four fields, and then the TOP field of an R video image is sent during the subsequent second field. After that, the BOTTOM field of the L video image is sent during the subsequent third field, and then the BOTTOM field of the R video image is sent during the fourth field. By transmitting four fields of a 3D video image in such an order while adding a V synchronizing signal once for every four fields, display device 200 can easily identify the four fields from the V synchronizing signal. By continuously transmitting pairs of the TOP fields of R and L video images and those of the BOTTOM fields, processes at display device 200 are simplified. Here, the above transmission formats are generated by format converting unit 104 of recording and reproducing device 100 in FIG. 1 and are transmitted from recording and reproducing device 100 to display device 200 by HDMI transmitting unit 110. FIG. 9 shows an example of mapping 3D video image data onto the currently used HD signal transmission format of 1125/60 i. As shown in FIG. 9, by merely inserting 3D video image data (instead of 2D video image data) into the data area of a conventional HD signal, 3D video image data can be easily transmitted.

Meanwhile, to transmit 3D video image data in the same transmission band as that for regular 2D video image data, respective L and R video image data need to be contracted to a half for transmission, thus halving the resolution. Meanwhile, to transmit 3D video image data using twice the width of the transmission band for 2D video image data, L and R video image data can be transmitted in their original size, thus maintaining the original resolution. The parameter “image size” represents the resolution of 3D video images thus determined by a transmission line (band). The value (0: not squeezed) indicates that the screen size is not contracted and the resolution is not decreased. The value (1: horizontal half size) indicates that an image is contracted horizontally to half (a half horizontal resolution). The parameter relates to a case when transmitted by the dot interleaved method and side by side method.

Meanwhile, the value (2: vertical half size) indicates that a video image is contracted vertically to a half (the vertical resolution is halved). The parameter relates to a case when transmitted by the line interleaved method and over under method.

The parameter “parallax compensation” relates to parallax compensation. This is different from “parallax compensation” described in FIG. 3. That is, FIG. 3 shows a parameter for parallax compensation at display device 200 while this case shows parallax compensation at recording and reproducing device 100. The parameter takes either (0: parallax not compensated) or (1: parallax compensated). If (0: parallax not compensated), “side priority” is defined, indicating (0: not defined), (1: left side), or (2: right side).

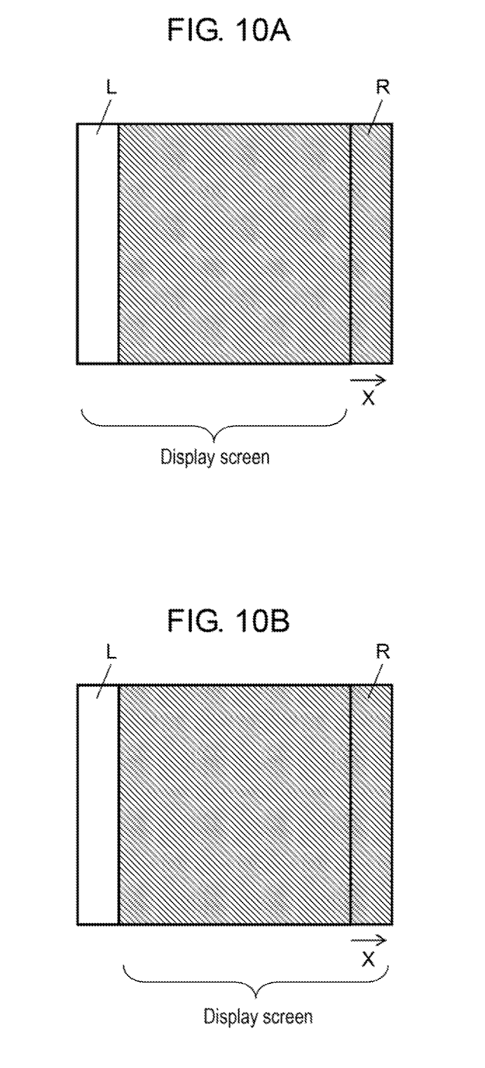

Here, a description is made of the meaning of side priority. If parallax is not compensated at recording and reproducing device 100, parallax needs to be compensated at display device 200 in some cases. As shown in FIGS. 10A and 10B, when display device 200 shifts an R video image to the right by X pixels with respect to the L video image, there are two different displaying ways: the L video image is displayed fully on the screen as in FIG. 10A (left-side priority), and the R video image is displayed fully on the screen as in FIG. 10B (right-side priority). The above description assumes that an R video image is shifted to the right by X pixels with respect to the L video image. Conversely, if an R video image is shifted to the left by X pixels with respect to the L video image, the situation is the same although the L and R video images are opposite to each other.

If “parallax compensation” is (1: parallax compensated), “assumed width of display” (unit: cm), which is the screen size of display device 200 assumed when compensated by recording and reproducing device 100, can be sent, where “assumed width of display” is changeable within the range 0 to 9,999 cm.

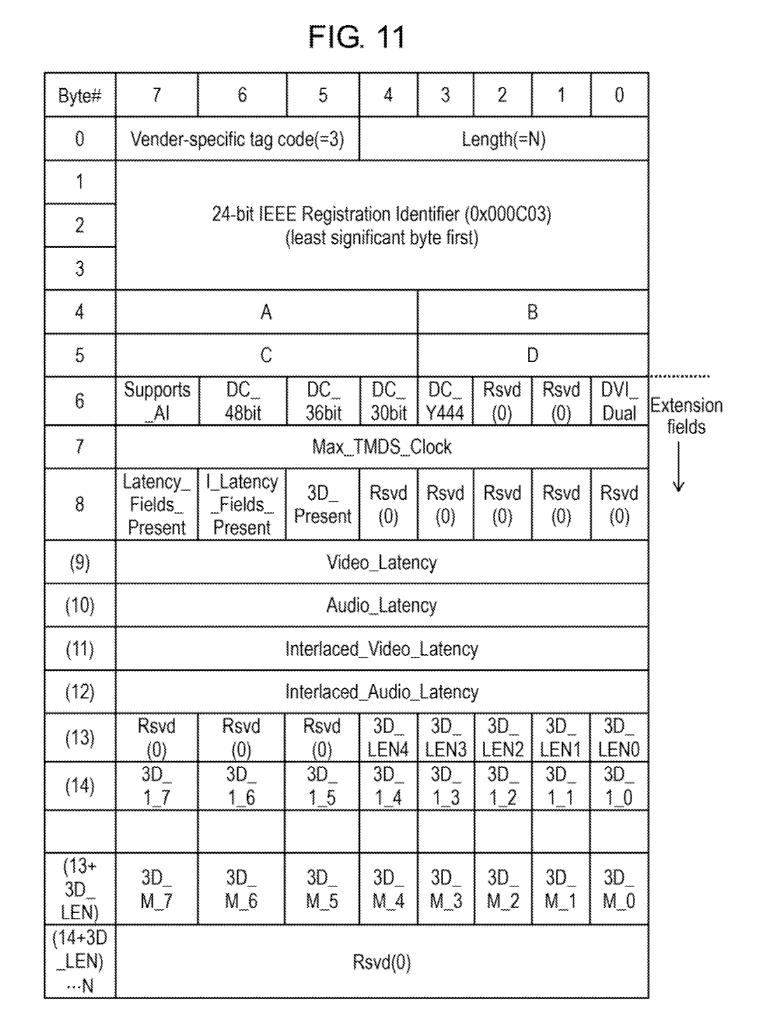

Next, a description is made of a method of transmitting a parameter related to 3D video images described in FIGS. 3 and 6, using FIGS. 11 through 13. As described in FIG. 2, to transmit control information between a transmission side (source) and a receiving side (sink) by the HDMI standard, three types of transmission lines are available: a TMDS channel (AVI infoFrame), DDC (EDID), and a CEC channel. Hence, when transmitting the respective parameters related to 3D video images described above by a most suitable method, resources of devices and bands of transmission lines can be effectively used.

In this embodiment, information of group A in FIG. 3 is acquired as EDID information through DDC, and information of group B is acquired through a CEC channel. Information of group B is of a large amount (e.g. size information on video images and the screen) or static information with low necessity for real-time transmission. Acquiring such information of group B through a CEC channel allows saving the capacity of EDID_ROM 213. The parameter “format” in FIG. 6 is sent as information on AVI infoFrame using a TMDS channel.

FIG. 11 illustrates the format (a memory map of EDID_ROM 213) of EDID, showing the format for mapping information of group A in FIG. 3 onto HDMI VSDB (vendor-specific data block) in EDID. The parameter “3D_present” is allocated to bit #5 of byte #8 of VSDB. If “3D_present” is 1, it indicates a 3D field is present; if 0, not present. If a 3D field is present, a given number of bytes from byte #13 are secured according to the 3D field length. The 3D field length is defined by 3D_LEN4 through 3D_LENO allocated to the five bits from bit #4 through bit #0 of byte #13. Data of the length (M bytes) defined by 3D_LEN appears from byte #14 through byte #(13+M). The field from byte #(14+3D_LEN) through byte #N is unused (reserved). Consequently, among parameters related to the display capability (transmission format and display method) of 3D video images of display device 200, the parameters: “3D capable”, “3D video image”, and “3D format” are allocated to the predetermined position “3D_X” and stored in EDID_ROM 213 as EDID information.

Next, a description is made of AVI infoFrame superimposed during a blanking period of video images to be transmitted.

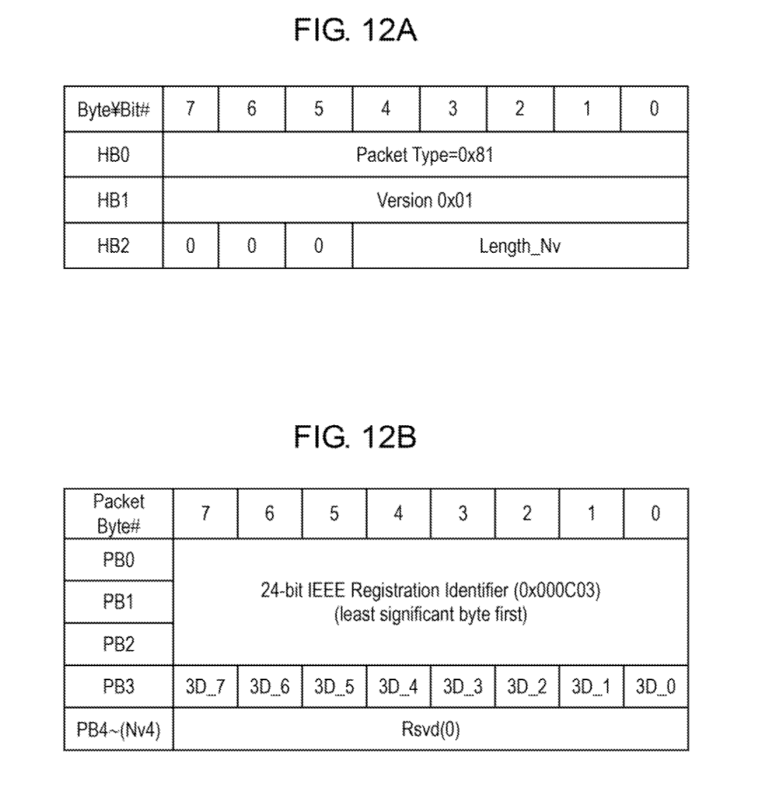

FIGS. 12A and 12B illustrate the format of AVI infoFrame, showing the format of HDMI Vendor Specific infoFrame. FIG. 12A shows a configuration of HDMI Vendor Specific infoFrame Packet Header. FIG. 12B shows a configuration of HDMI Vendor Specific infoFrame Packet Contents.

First, to declare that the infoFrame is a vendor's own infoFrame, Packet Type=0×81 is described in byte #HBO of the packet header, and Version 0×01 is described in byte #HB1. Further, the payload length (Nv) of vendor infoFrame is described in the five bits (bit #4 through bit #0) of byte #HB2.

The vendor ID registered to IEEE is described in the three bytes (byte #PB0 through byte #PB2) of the packet contents. Data (3D_7 through 3D_0) is described in byte #PB3 (data area), and byte #PB4 through byte #PB(Nv-4) are reserved (0). That is, each parameter of the transmission format of 3D video images in FIG. 6 is described in this data area.

In the above description, the size of the data area is 1 byte (byte #PB3), which is because all the parameters of the transmission format shown in FIG. 6 are assumed to be transmitted with one code. The size of the data area is not limited to one, but to transmit all the parameters of the transmission format shown in FIG. 6, a data area required for it can be secured.

Part of the transmission format shown in FIG. 6 can be sent through a CEC channel as well.

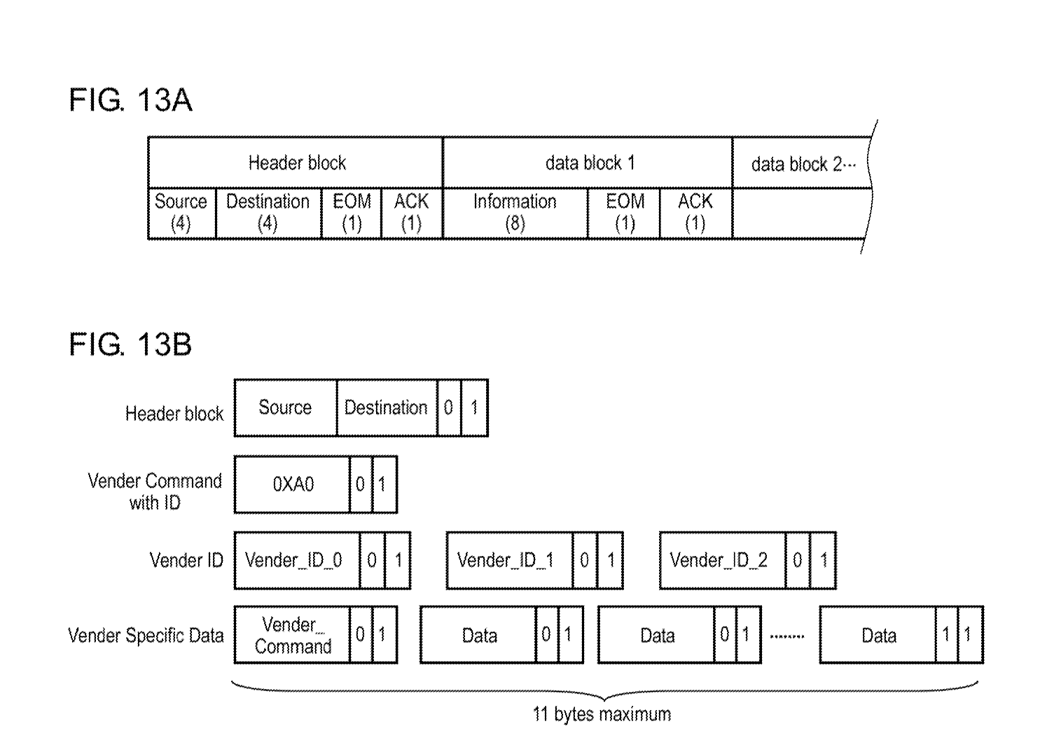

FIGS. 13A and 13B illustrate a CEC format, showing a format for transmitting a parameter of group B in FIG. 3 through a CEC channel. With CEC, information is transmitted as a message. FIG. 13A shows a packet structure of a CEC frame constituting a message. FIG. 13B shows an example CEC frame for sending a parameter of group B in FIG. 3.

In FIG. 13A, a CEC frame is composed of a header block and data blocks 1 through N (N=1 to 13). In the header block, the addresses (4 bits each) of a source and a destination are described. Each data block includes 1-byte information, where a command is sent with data block 1, and arguments (parameters) are sent with data block 2 and after. Every block has 1-bit EOM (end of message) appended thereto indicating whether the block has a subsequent block (0) or the message ends at the block (1). In the same way, every block includes 1-bit ACK (acknowledge), where the sender sets 1 to ACK and sends the message, and the receiver sets 0 to ACK if the message is addressed to itself or replies with ACK remaining 1 if the message is not addressed to itself.

CEC provides a vendor's own message for a vendor command, with which a vendor can exchange vendor's own commands and arguments between devices. A description is made of how to transmit a parameter of group B in

FIG. 3 using a CEC vendor command. In FIG. 13B, subsequently to the header block, the value “0×A0” indicating that the command is a vendor command with ID is sent, and then the vendor ID is sent with the following three blocks. After that, the vendor specific data is sent. The first block of the vendor specific data is a vendor command, followed by data blocks. One CEC message is composed of a maximum of 14 blocks, which means 11 blocks (11 bytes) of vendor specific data can be transmitted. In this embodiment, a command related to 3D video images is defined as a vendor command, with which a parameter of group B in FIG. 3 is sent.

### Second Exemplary Embodiment

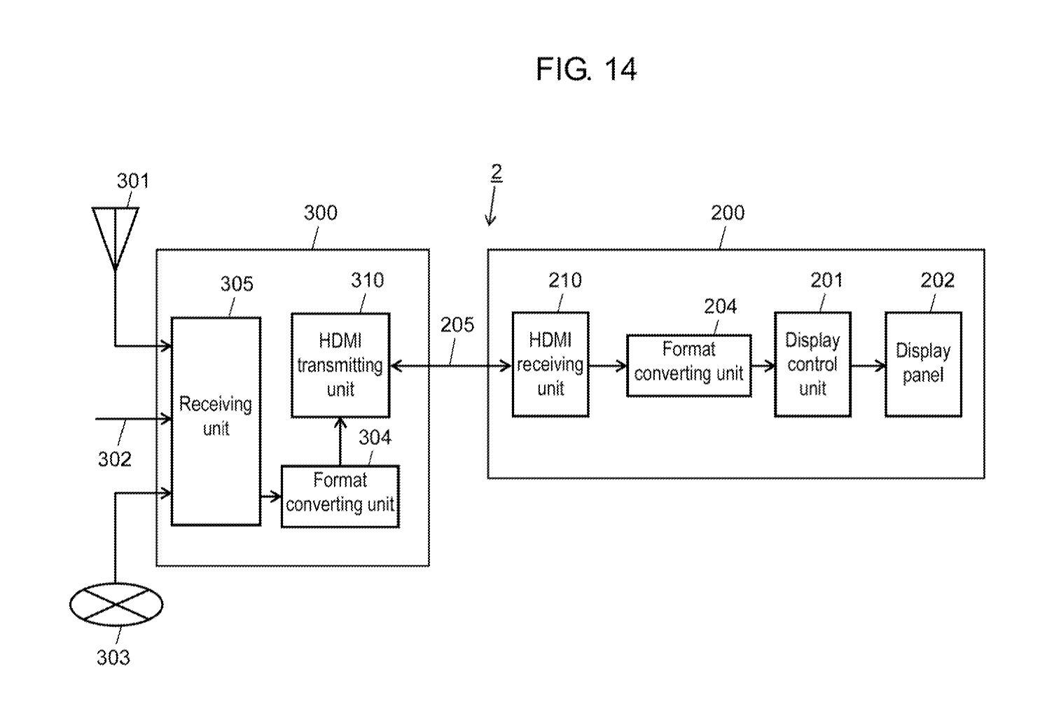

Next, a description is made of the second exemplary embodiment of the present invention using FIG. 14. FIG. 14 shows a configuration example of three-dimensional video image transmission system 2 according to the embodiment. System 2 is different from the first embodiment in that the video image output device has been changed from recording and reproducing device 100 to tuner 300. The other components are the same as those of the first embodiment, and thus the same component is given the same reference mark to omit its description.

Tuner 300 as a video image receiving device includes receiving unit 305, format converting unit 304, and HDMI transmitting unit 310. and is connected to antenna 301, coaxial cable 302, and Internet 303. 3D video images broadcast from a broadcasting station (not shown) are received by receiving unit 305 (i.e. a video image acquiring unit) through antenna 301 in a predetermined receiving format. The 3D video images received are converted into a transmission format, receivable by display device 200, preliminarily acquired by format converting unit 304 and are output to display device 200 through HDMI transmitting unit 310.

3D video images broadcast from a cable broadcasting station (not shown) are input to receiving unit 305 through coaxial cable 302; 3D video images transmitted from a program distributing server (not shown) compliant with an IP (Internet Protocol) network are input to receiving unit 305 through Internet 303. Format converting unit 304 performs conversion compliant with the receiving format of 3D video images received from antenna 301, coaxial cable 302, or Internet 303. The subsequent operations are the same as those of the first embodiment, and thus their description is omitted.

Thus, according to 3D video image transmission system 2 of this embodiment, 3D video images in various types of formats sent from the outside of such as home can be displayed by being transmitted to display device 200 by tuner 300 having an HDMI terminal.

As described hereinbefore, the present invention allows a 3D video image transmission system composed of a video image output device and a display device connected to each other through HDMI to transmit parameters for transmitting and displaying 3D video images between the video image output device and the display device. Herewith, even if plural display devices with different display capabilities are connected to a 3D video image transmission system, 3D video image data can be transmitted without problems.

In the above embodiment, the description is made assuming that recording and reproducing device 100 is a DVD recorder, but not limited to, where other devices such as a BD recorder and a HDD (hard disk drive) recorder may be used.

In the above embodiment, the description is made of a case where a video image output device and a display device are connected with an HDMI cable compliant with the HDMI standard; however, devices may be connected wirelessly. When the wireless communication method is compliant with the HDMI protocol, the present invention is applicable, where 3D video image data to be transmitted is not limited to baseband video image data, but may be compressed video image data.

In the above embodiment, the description is made assuming that the HDMI standard is used; however, other transmission methods may be used as long as parameters representing the display capability of a display device described in the embodiment can be exchanged between devices.

### INDUSTRIAL APPLICABILITY

The present invention is widely applicable to a system sending and receiving three-dimensional video image data between devices connected through HDMI.

### REFERENCE MARKS IN THE DRAWINGS

100 Recording and reproducing device (video image output device)

101 Optical disc

102 Recording and reproducing unit

103 Codec

104, 204, 304 Format converting unit

110, 310 HDMI transmitting unit

111 TMDS encoder

112, 212 Packet processing unit

200 Display device (video image display device)

201 Display control unit

202 Display panel

210 HDMI receiving unit

211 TMDS decoder

213 EDID ROM

300 Tuner

301 Antenna

302 Coaxial cable

303 Internet

305 Receiving unit (video image acquiring unit)

1. A three-dimensional video image transmission system comprising:
at least one video image display device for displaying a three-dimensional video image; and
at least one video image output device for outputting a three-dimensional video image,
wherein the three-dimensional video image transmission system transmits a three-dimensional video image output by the video image output device to the video image display device through an interface compliant with an HDMI (High Definition Multimedia Interface) standard,
wherein the three-dimensional video image is formed of left- and right-eye video images,
wherein first interlaced scan data of the left- and right-eye video images is transmitted during a first field and a second field subsequent to the first field, and
wherein second interlaced scan data complementary to the first interlaced scan data is transmitted during a third field subsequent to the second field and a fourth field.

2. A video image display device for receiving a three-dimensional video image output by a video image output device through an interface compliant with an HDMI standard and for displaying the image, in a three-dimensional video image transmission system, the video image display device comprising:
an HDMI receiving unit for receiving three-dimensional video image data transmitted from the video image output device in a given transmission format;
a format converting unit for converting the transmission format into a display format;
a display unit for displaying a three-dimensional video image converted to the display format; and
a storage unit for storing information on capability of displaying a three-dimensional video image.

3. A video image output device for acquiring a three-dimensional video image and for transmitting the image to a video image display device through an interface compliant with an HDMI standard, in a three-dimensional video image transmission system, the video image output device comprising:
a video image acquiring unit for acquiring a three-dimensional video image in a given video image format;
a format converting unit for converting the given video image format into a transmission format; and
an HDMI transmitting unit for transmitting three-dimensional video image data converted into the transmission format.
